(19) United States
(12) Patent Application Publication
(10) Pub. No.: US 2025/0024818 A1
(43) Pub. Date: Jan. 23, 2025

(54) KEEPING FACILITY FOR KEEPING POULTRY ANIMALS, RELATED POULTRY ANIMAL KEEPING HOUSE, KEEPING METHOD AND USE

(71) Applicant: BIG DUTCHMAN INTERNATIONAL GMBH, Vechta (DE)

(72) Inventors: ROLF WICHMANN, VECHTA-BERGSTRUP (DE); ANGELIKA JÜRGENS, HATTEN (DE)

(73) Assignee: BIG DUTCHMAN INTERNATIONAL GMBH, Vechta (DE)

(21) Appl. No.: 18/774,294

(22) Filed: Jul. 16, 2024

(30) Foreign Application Priority Data
Jul. 19, 2023 (LU) 504770

(51) Int. Cl. A01K 31/18; A01K 31/00

(52) U.S. Cl. CPC A01K 31/18; A01K 31/007

(57) ABSTRACT

A keeping facility for keeping poultry animals includes a floor defining a first dwelling surface for laying hens and an inlay defining a second dwelling surface for rearing chicks, wherein the inlay is detachably arranged above the floor. The floor defining the first dwelling surface and/or the inlay defining the second dwelling surface are formed as a mesh floor.

### CROSS-REFERENCE TO FOREIGN PRIORITY APPLICATION

The present application claims the benefit under 35 U.S.C. §§ 119(b), 119(e), 120, and/or 365(c) of Luxembourg Application No. LU504770 filed Jul. 19, 2023.

### FIELD OF THE INVENTION

The invention relates to a keeping facility for providing poultry animals with a floor, in particular a mesh floor, for providing a dwelling surface for laying hens.

### BACKGROUND OF THE INVENTION

Keeping facilities of this type are known from the prior art, such as, for example, from the EP 3 824 726 A2. They are used for keeping laying hens for the purpose of egg production and typically have mesh floors, which are formed, for example, as wire floors and which are formed in a large-meshed manner and often also to be inclined. Due to the inclination of the mesh floor, system eggs roll off, so that eggs can be collected by hand. It is known for keeping facilities of this type to fixedly install feeding and drinking troughs, so that fully grown animals can reach them well. Keeping facilities of this type are not suitable for rearing chicks. For the chicks, the floor inclination is just as unsuitable as the frequently used floor mesh widths. There would also be a high risk of injury for the chicks. Chicks could likewise reach feeding troughs and drinking troughs only insufficiently.

Keepings systems for rearing chicks or pullets, respectively, are further known from the prior art, which have a close-meshed mesh floor, which is arranged mostly horizontally and in the case of which the height of the drinking trough lines and feeding troughs can be adapted.

The separation known from the prior art between rearing and egg production by means of a keeping system designed specifically for laying hens entails that a rehousing is required between rearing and productive laying hen keeping. A rehousing of this type is complex, can have a negative impact on the animal performance, and can furthermore release CO₂ due to the required transport. Added to this is the often missing care for the animals during the transport, the need to catch the animals, and to load them, as well as bringing the animals into an unfamiliar environment with temperature fluctuations, a new group composition/hierarchy, and possibly a changed daily routine.

It is thus the object of the invention to overcome the disadvantages encountered in the prior art as much as possible. In particular, a keeping facility for keeping poultry animals was to be specified, in the case of which stress for the animals caused by rehousing processes is reduced, the animal well-being and the performance of the animals is maintained, and transportation costs as a whole are reduced.

### SUMMARY OF THE INVENTION

With regard to the keeping facility, the invention solves the above-identified object in that it has at least one dwelling surface detachably arranged above the floor or an inlay for rearing chicks, wherein the dwelling surface and/or the inlay are formed in particular as inlay mesh floor.

The invention uses the knowledge that with the use of an inlay for rearing chicks, which is detachably arranged above the floor, day-old chicks can be reared inside the keeping facility and until the beginning of the laying period, in order to then use the same keeping facility for the laying hen operation after removal of the inlay. In other words, the invention is based on the idea of temporarily configuring a keeping facility, which is optimized for keeping laying hens, in such a way by means of the inlay that said keeping facility is also suitable for rearing chicks, without creating disadvantages for the subsequent laying operation. The inlay is removed for the laying operation.

It is achieved thereby that a rehousing is not required between the rearing and the laying hen operation. The animal well-being is promoted in this way, a possible drop in performance due to the stress associated with the rehousing is avoided, and transport costs as a whole as well as the CO2-carbon footprint are reduced.

In addition to increasing animal well-being, the egg producer can thus achieve that a keeping facility can also be used for rearing day-old chicks by means of relatively small modifications. Getting started with chick rearing is simplified thereby. The marketing of the produced eggs is furthermore promoted due to the increased animal well-being.

According to one embodiment, the floor is inclined with respect to a horizontal by an angle of inclination, wherein the inlay has a smaller angle of inclination than the floor. The inlay is preferably arranged horizontally. A horizontal arrangement of the inlay has proven to be particularly suitable for rearing chicks.

According to one embodiment, the keeping facility has a feeding facility with a feeding trough, wherein the inlay is suspended on the feeding trough or is attached to the feeding trough. The inlay can be fastened easily and securely to the feeding trough in this way, whereby it is ensured at the same time that the feeding trough is easily accessible by the chicks, which are located on the inlay. In the case of a horizontal arrangement of the inlay, it is furthermore made possible that the inlay can rest completely on the feeding trough. It is further avoided that chicks get caught and can injure themselves.

According to one embodiment, the floor and the inlay are formed as mesh floor, wherein a mesh width of the inlay differs from a mesh width of the floor. The inlay in particular has a smaller mesh width than the floor. Due to the mesh width in combination with an essentially horizontally arranged inlay, it is achieved that food arranged on the inlay cannot be scraped away in the direction of a slope. The small mesh width furthermore ensures that the animals can neither get caught nor injure themselves during the entire rearing period. In particular, injuries caused by stepping through a floor, which is too coarsely meshed, are prevented. With reference to the floor, it is ensured by means of the coarse meshes that a corresponding self-cleaning is made possible in the laying operation.

According to one embodiment, the inlay is formed in several pieces, in particular in three pieces. By dividing the inlay, the latter can be mounted and removed easily. Due to the multi-piece formation of the inlay, the latter can be connected particularly advantageously to the feeding troughs or can be suspended in them, respectively. It is avoided thereby that chicks get caught under the feeding troughs.

According to an alternative embodiment, the inlay is formed in one piece and extends in particular over the entire width of a corresponding section of the keeping facility. According to an alternative embodiment, the inlay can be formed so as to be capable of being inserted laterally in the manner of a drawer. In this respect, the inlay can be inserted in particular from the outside or from an inner walkway in one piece or in several pieces.

According to one embodiment, the keeping facility has an approach tray, which is arranged adjacent to a steeply sloping end of the floor and wherein a roll-off gap is formed between the floor and the approach tray, which roll-off gap is dimensioned in such a way that eggs can roll off between the floor and the approach tray, wherein the inlay has a section, which is essentially horizontal in the mounted state and a section, which runs essentially vertically in the mounted state, and wherein the section, which runs essentially vertically, closes the roll-off gap at least partly, in particular completely. It is avoided thereby that chicks can get caught in the area of the roll-off gap.

According to one embodiment, the feeding facility has at least one drinking trough, wherein the drinking trough is formed to be height-adjustable and/or wherein the feeding facility has at least one feeding trough and wherein the feeding trough is formed to be height-adjustable in such a way that the drinking trough and/or the feeding trough is accessible from the floor and the inlay. It can be ensured in this way that the water and food supply is ensured for the different growth stages of the chicks or pullets, respectively, and also for the productive laying operation. The drinking trough and the feeding trough can be set so that the chicks can access them from the inlay. They can furthermore be adapted to the continued animal growth and can also be configured after the removal of the inlay so that the fully grown animals can access them well.

According to one embodiment, the keeping facility has at least one nest and/or an egg roll-off system and least one safety gate, which is detachably arranged on the keeping facility and which is configured to block off the nest and/or the egg roll-off system. It can be achieved in this way that the chicks are initially only accommodated in a limited area of the keeping facility, whereby it is ensured in this area that the chicks encounter the conditions required for the rearing, i.e., that there is in particular no risk of getting caught, and food and water are easily accessible and the inlay has the corresponding mesh width. With increasing growth of the chicks or pullets, respectively, the safety gate can be removed, whereby further areas of the keeping facility become accessible, for example the nest and/or the egg roll-off system. Chicks cannot reach this area and are thus effectively protected against injuries, for example due to getting caught in the egg roll-off system or the nest. According to one embodiment, the keeping facility has a gate on the gangway side, which is configured to block the chicks from accessing a gangway.

According to one embodiment, the keeping facility has a perch, wherein the perch is formed to be height-adjustable. While rearing chicks, the perch can in particular be adjusted in such a way that there is also no risk whatsoever here of getting caught between perch and further components of the keeping facility.

According to one embodiment, the keeping facility has at least one lateral partition wall with ventilation openings, and wherein ventilation openings arranged adjacent to the inlay have a smaller opening diameter than those ventilation openings, which are not arranged adjacent to the inlay. By means of the reduction of the opening diameter in the area of the inlay, it is ensured that the risk of getting caught in the ventilation openings or of getting injured on them is also reduced for the chicks with regard to the ventilation openings.

The rearing of the day-old chicks and the subsequent configuration for the laying hen operation preferably take place in three phases. In a first phase, the chicks are located on the inlay. The inlay or the inlays are preferably suspended on the feeding trough. The feeding trough as well as the perch are moved into an upper position and the corresponding area of the feeding facility, also referred to as level, is closed by means of exterior gates. With increasing growth of the chicks up to pullets, the inlays are removed and the perch or feeding troughs, respectively, are brought into a lower position. The exterior gates still remain closed, whereby an exterior gate is positioned in the direction of an interior walkway in such a way that further areas of the keeping facility, in particular a level arranged above the described area with an inclined floor are unblocked. In a third phase, the keeping facility is configured in such a way that a laying hen operation can take place. The exterior gate is opened for this purpose and a gate in the direction of an interior walkway is also removed. The nests and egg roll-off systems as well as further areas of the keeping facility now become accessible in this way. In this configuration, the keeping facility resembles essentially existing laying hen keeping facilities.

The invention has been described above with reference to a keeping facility. In a further aspect, the invention relates to a poultry animal house for keeping poultry animals, in particular a laying hen house, comprising a keeping facility. The invention solves the above-identified object with regard to the poultry animal house, in which the keeping facility is formed according to one of the above claims. The poultry animal house utilizes the same advantages and preferred embodiments as the keeping facility according to the invention and vice versa. In this respect, reference is made to the above explanations and the content thereof is included hereby.

In a further aspect, the invention relates to a method for keeping poultry animals. With regard to the method, the invention solves the above-identified object in that it has the steps of: providing a keeping facility according to at least one of the preceding exemplary embodiments, housing poultry animals, in particular day-old chicks, on the inlay, rearing the chicks to become laying hens, removing the inlay after rearing the chicks, keeping the laying hens on the floor of the keeping facility.

By means of the method according to the invention, it is achieved in summary that day-old chicks can be reared inside the keeping facility until the beginning of the laying period and the same keeping facility can then be used for the laying hen operation, whereby a rehousing between rearing and laying hen operation can be avoided. The stress for the animals is reduced thereby, transport costs and CO2 emission are lowered, and the animal well-being as a whole is promoted. The method additionally utilizes the same advantages and preferred embodiments as the keeping facility according to the invention and the poultry animal house according to the invention and vice versa. In this respect, reference is made to the above explanations and the content thereof is included hereby.

In a further aspect, the invention relates to the use of a keeping facility according to at least one of the preceding exemplary embodiments for keeping poultry animals, in particular laying hens or day-old chicks, in a poultry animal house, preferably in a poultry animal house according to the above exemplary embodiment. The use also utilizes the same advantages and preferred embodiments as the keeping facility according to the invention, the poultry animal house according to the invention, and the method according to the invention and vice versa. In this respect, reference is made to the above explanations and the content thereof is included hereby.

### BRIEF DESCRIPTION OF THE DRAWINGS

The invention will be described in more detail below on the basis of a preferred exemplary embodiment with reference to the enclosed Figures, in which:

FIG. 1 shows an exemplary embodiment of a keeping facility according to the invention arranged in a poultry animal house in a sectional view;

FIG. 2 shows a plane of the keeping facility according to the invention according to FIG. 1 in a sectional view;

FIGS. 3 and 4 show detailed views of the keeping facility according to the invention according to FIGS. 1 and 2 in perspective views; and

FIGS. 5 and 6 show detailed views of inlays including fastening in perspective views.

### DETAILED DESCRIPTION OF TH EMBODIMENTS

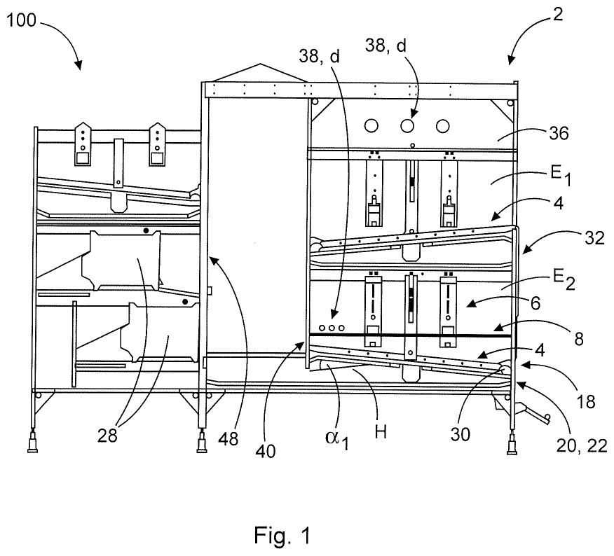

FIG. 1 shows a poultry animal house 100 illustrated in an exemplary manner for keeping poultry animals. The poultry animal house 100 comprises a keeping facility 2. The keeping facility 2 is formed for keeping poultry animals and is suitable for rearing chicks as well as for the laying hen operation. The keeping facility 2 has a floor 4, which is arranged so as to be inclined by an angle of inclination al with respect to a horizontal H. The floor 4 is formed as mesh floor 4. The floor 4 provides a dwelling surface for the laying hens, whereby the angle of inclination al of the floor 4 ensures that eggs can roll off in the direction of an egg roll-off system 30. In the exemplary embodiment shown in FIG. 1, the keeping facility 2 has a first level E1 and a second level E2. A floor 4 is arranged in both levels E1, E2. An inlay 8 for rearing chicks, which is detachably arranged above the floor 4, is furthermore arranged in the lower level E2. The inlay 8 is formed as inlay mesh floor. The inlay 8 is essentially arranged horizontally and thus has a lower angle of inclination than the floor 4.

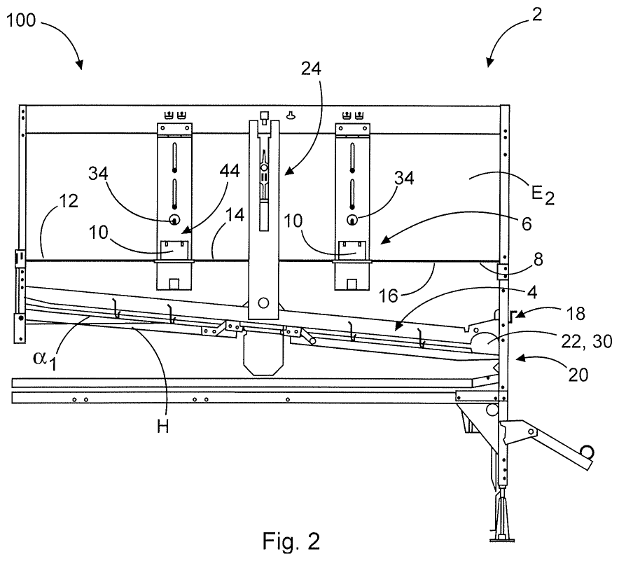

The keeping facility 2 has a feeding facility 6, which is detailed in particular in FIG. 2. The feeding facility 6 has a feeding trough 10. The inlay 8 is suspended on the feeding trough 10 or is attached thereto. As shown in FIG. 2, the inlay 8 is formed in three pieces, i.e., it has a first inlay segment 12, a second inlay segment 14, and a third inlay segment 16. The keeping facility 2 further has an approach tray 18. The approach tray 18 is arranged adjacent to a steeply sloping end 20 of the floor 4. A roll-off gap 22 is formed between the floor 4 and the approach tray 18. Said roll-off gap is dimensioned in such a way that eggs can roll off between the floor 4 and the approach tray 18. The feeding trough 10 is formed to be height-adjustable in such a way that the feeding trough 10 is accessible from the floor 4 and the inlay 8 and can be adapted, depending on the operating stage of the keeping facility 2, i.e., in particular with reference to the size of the animals and to the fact whether the animals are kept on the inlay 8 or the floor 4.

The feeding facility further has a drinking trough, which is likewise formed to be height-adjustable. The feeding facility 2 additionally has at least one perch 34, which is likewise formed to be height-adjustable. With reference to FIG. 1, the keeping facility 2 furthermore has a safety gate 32 as well as an interior gate 40. The dwelling area, in particular for the chicks, which are accommodated on the inlay 8, can be restricted by means of the gates 32, 40, so that a risk of injury is reduced. The keeping facility 2 further has a lateral partition wall 36. The lateral partition wall 36 has ventilation openings 38. Ventilation openings 38 arranged adjacent to the inlay 8 have a smaller opening diameter d than those ventilation openings 38, which are not arranged adjacent to the inlay 8. The ventilation openings 38 are only illustrated in an exemplary manner in FIG. 1.

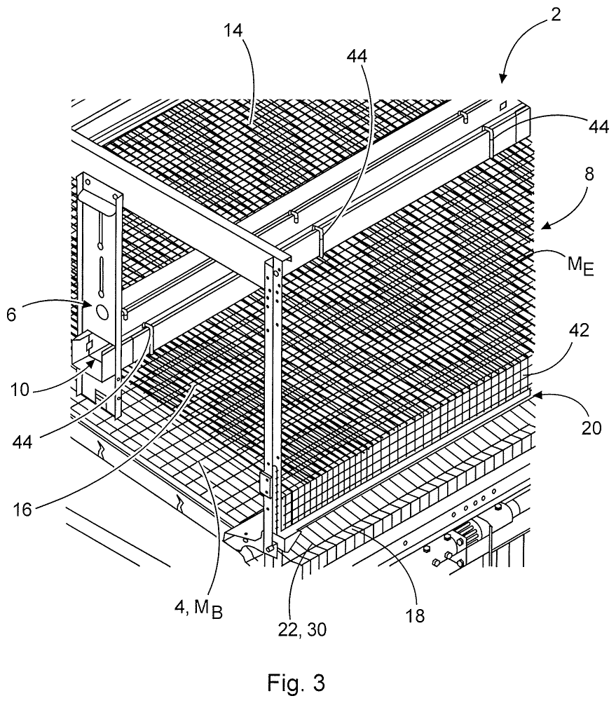

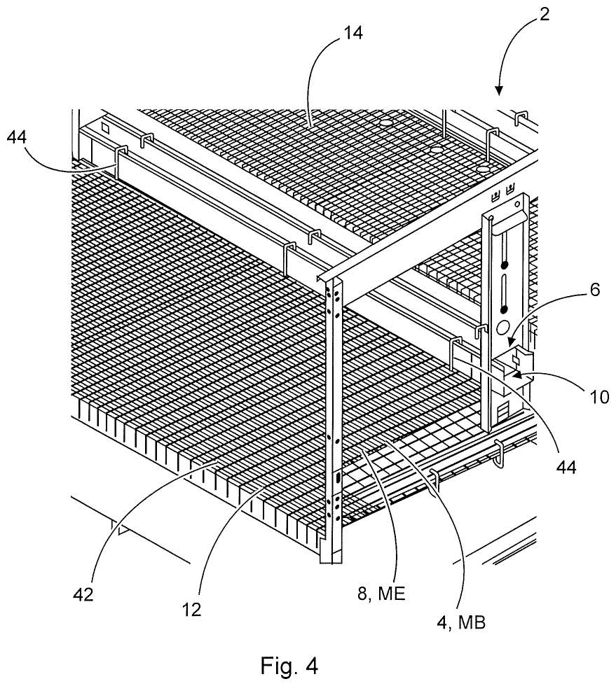

FIGS. 3 and 4 show details of the keeping facility 2 in perspective illustrations. It can be seen in the Figures that hooks 44 are assigned to the inlay 8, which hooks are configured to engage with the feeding trough 10. The floor 4 and the inlay 8 are furthermore formed as mesh floor 4, 8. The floor 4 has a mesh width MB. The inlay 8 has a mesh width ME. The mesh width ME of the inlay 8 differs from the mesh width MB of the floor, namely in such a way that the inlay 8 has a smaller mesh width ME than the floor 4. With reference to the inlay 8, it is ensured thereby that the chicks are not injured due to a mesh width, which is too large. In the laying operation, the larger mesh width ensures that dirt particles are safely discharged downward. As can be seen in FIGS. 3, 4, and 5 the inlay 8 has a horizontal section 46 on which the chicks are accommodated, which is essentially horizontal in the mounted state. The inlay 8 furthermore has a section 42, which runs essentially vertically in the mounted state, whereby the vertically running section 42 at least partly, in particular completely, closes the roll-off gap 22, in order to also reduce a possible risk of injury for the chicks here.

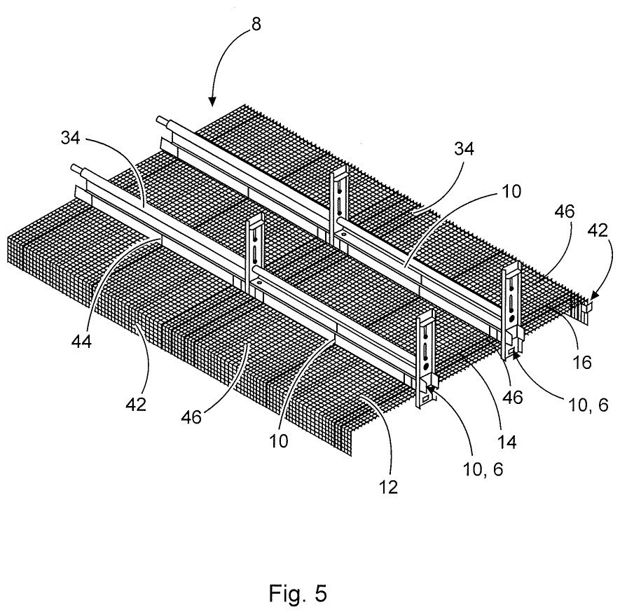

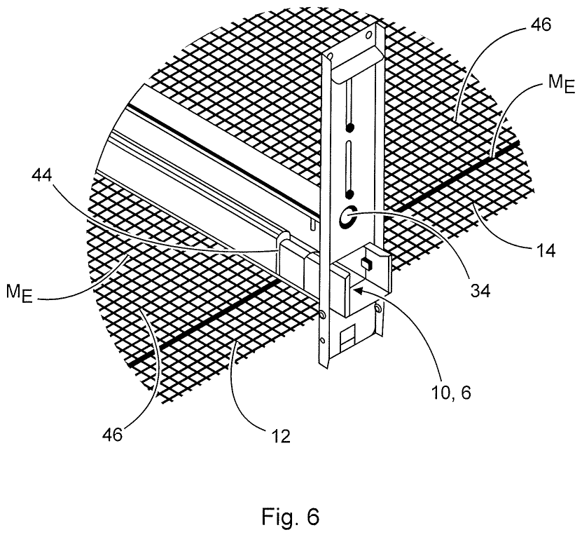

The configuration and the suspension of the inlay 8, which consists of the segments 12 to 16, is specified in FIGS. 5 and 6. The exterior inlay segments 12, 16 have a vertical section 42 as well as a horizontal section 46. The second inlay segment 14 has only a horizontal section 46. The respective inlay segments 12, 14, 16 are suspended in the feeding troughs 10 with the help of hooks 44.

With reference to FIGS. 1 and 2, the method for rearing chicks with subsequent laying operation will be described below. Based on the configuration shown in FIG. 1, in the case of which the inlay 8 is inserted into the keeping facility 2, the perches 34 and the troughs 10 are additionally brought into an upper position, so that they are accessible for the day-old chicks. The gates 32, 40 are closed and the dwelling area of the chicks is thus restricted to the plane E2. With increasing growth of the chicks or pullets, respectively, the inlay 8 is then removed and the perches 34 as well as the troughs 10 are transferred into a lower position. The gate 32 remains closed, the gate 40, in turn, is opened. In this respect, both levels E1, E2 are now accessible for the young animals and furthermore the area to the left of the interior gate 40. The nests 28 are not accessible, however.

After the conclusion of the rearing process, the gate 40 as well as the gate 32 are now removed for the purpose of the laying operation. All areas of the keeping facility 2 are thus accessible for the animals thereafter. This includes the nests 28. The configuration of the keeping facility 2 now resembles the facilities known from the prior art for the laying operation.

1.-14. (canceled)

15. A keeping facility for keeping poultry animals comprising:
a floor defining a first dwelling surface for laying hens; and
an inlay defining a second dwelling surface for rearing chicks, wherein the inlay is detachably arranged above the floor;
wherein the floor defining the first dwelling surface and/or the inlay defining the second dwelling surface are formed as a mesh floor.

16. The keeping facility according to claim 15, wherein the floor is inclined with respect to a horizontal plane by an angle of inclination and wherein the inlay has a smaller angle of inclination with respect to the horizontal plane than the floor.

17. The keeping facility according to claim 16, wherein the inlay is arranged horizontally.

18. The keeping facility according to claim 15, wherein the keeping facility has a feeding facility with a feeding trough and wherein the inlay is suspended on the feeding trough or is attached to the feeding trough.

19. The keeping facility according to claim 18, wherein hooks are assigned to the inlay and the hooks are configured to engage with the feeding trough.

20. The keeping facility according to claim 15, wherein both the floor and the inlay are formed as a mesh floor and wherein a mesh width of the inlay differs from a mesh width of the floor.

21. The keeping facility according to claim 20, wherein the mesh width of the inlay is smaller than the mesh width of the floor.

22. The keeping facility according to claim 15, wherein the inlay is formed in several pieces.

23. The keeping facility according to claim 22, wherein the inlay is formed in three pieces.

24. The keeping facility according to claim 15, wherein:
the keeping facility has an approach tray arranged adjacent to a sloping end of the floor and wherein a roll-off gap is formed between the floor and the approach tray, the roll-off gap being dimensioned in such a way that eggs can roll off between the floor and the approach tray; and
the inlay has a horizontal section which is mounted substantially horizontally in the mounted state and a vertical section which extends substantially vertically in the mounted state, and wherein the vertical section partially or completely closes the roll-off gap.

25. The keeping facility according to claim 15, wherein the feeding facility has at least one drinking trough and wherein the drinking trough is formed to be height-adjustable and/or wherein the feeding facility has at least one feeding trough and wherein the feeding trough is formed to be height-adjustable in such a way that the drinking trough and/or the feeding trough is/are accessible from the floor and the inlay.

26. The keeping facility according to claim 15, wherein the keeping facility has at least one nest and/or an egg roll-off system and least one safety gate detachably arranged on the keeping facility and which is configured to block off the nest and/or the egg roll-off system.

27. The keeping facility according to claim 15, wherein the keeping facility has a perch and wherein the perch is formed to be height-adjustable.

28. The keeping facility according to claim 15, wherein the keeping facility has at least one lateral partition wall with ventilation openings and wherein the ventilation openings that are arranged adjacent to the inlay have a smaller opening diameter than the ventilation openings that are not arranged adjacent to the inlay.

29. A poultry animal house for keeping poultry animals, comprising a keeping facility according to claim 15.

30. A method for keeping poultry animals, the method comprising the steps of:
providing a keeping facility according to claim comprising a floor defining a first dwelling surface for laying hens and an inlay defining a second dwelling surface for rearing chicks, wherein the inlay is detachably arranged above the floor, and wherein the floor defining the first dwelling surface and/or the inlay defining the second dwelling surface are formed as a mesh floor;
housing day-old chicks on the inlay;
rearing the chicks to become laying hens;
removing the inlay after rearing the chicks; and
keeping the laying hens on the floor of the keeping facility.

31. A method of using of a keeping facility for keeping poultry animals with a poultry animal house, the method comprising the steps of:
providing a floor defining a first dwelling surface for laying hens; and
providing an inlay defining a second dwelling surface for rearing chicks, wherein the inlay is detachably arranged above the floor;
wherein the floor defining the first dwelling surface and/or the inlay defining the second dwelling surface are formed as a mesh floor.
